(19) United States
(12) Patent Application Publication
(10) Pub. No.: US 2024/0153376 A1
(43) Pub. Date: May 9, 2024

(54) METHOD, APPARATUS, AND COMPUTER PROGRAM PRODUCT FOR DATA ATTRIBUTION

(71) Applicant: HERE GLOBAL B.V., Eindhoven (NL)

(72) Inventor: Dennis Scott WILLIAMSON, Wheaton, IL (US)

(21) Appl. No.: 18/053,075

(22) Filed: Nov. 7, 2022

(51) Int. Cl. G08G 1/01

(52) U.S. Cl. CPC G08G 1/0112; G08G 1/0141; G08G 1/0125

(57) ABSTRACT

A method, apparatus and computer program product are provided for analyzing sensor data from roads of the road network to monitor sensor data usage, which can in turn be used for value estimation and compensation for data usage. Methods may include: aggregating observations and vehicle paths from sensor data from data sources; determining observation counts for each of the data sources; collapsing aggregated vehicle paths to road topology by travel direction; assigning the observation counts to a nearest road topology; projecting an observation count for each of the data sources along a predetermined distance unit of the road topology to form observation intervals, each observation interval including a respective observation count; iterating over the road topology using the observation intervals to establish observation intervals and their respective observation counts; and determining a value of the sensor data based on lengths of the observation intervals and their respective observation counts.

### TECHNOLOGICAL FIELD

Example embodiments of the present invention relate generally to the attribution of sensor data along roads of a road network, and more particularly, to analyzing sensor data from roads of the road network to monitor sensor data usage, which can in turn be used for value estimation and compensation for data usage.

### BACKGROUND

Road geometry modelling is useful for high-definition (HD) map creation and updating. HD maps are useful for a variety of applications including navigational guidance and autonomous or semi-autonomous vehicle control. Traditional methods for 3D modelling of road geometry and object or feature detection are resource intensive, often requiring significant amounts of human measurement and calculation. Such methods are thus time consuming and costly. Exacerbating this issue is the fact that many modern-day applications (e.g., 3D mapping, terrain identification, or the like) require manual or semi-automated analysis of large amounts of data, and therefore are not practical without quicker or less costly techniques.

As vehicles become increasingly capable and are often fitted with highly capable arrays of sensors, the volume of sensor data available from drives among a road network increases exponentially. This crowd-sourced sensor data is voluminous and useful in building and healing of digital maps. The sensor data may be generated by a variety of different sources, and available through numerous service providers, original equipment manufacturers (OEMs), and software providers. To encourage these data sources to share collected sensor data, compensation may be necessary. However, determining how to compensate the data sources is complex, particularly since different data sources provide different volumes and different qualities of data.

### BRIEF SUMMARY

Accordingly, a method, apparatus, and computer program product are provided for automatic generation of maps, and more particularly, to a system for attribution of sensor data along roads of a road network, and more particularly, to analyzing sensor data from roads of the road network to monitor sensor data usage, which can in turn be used for value estimation and compensation for data usage.

Embodiments provided herein include an apparatus including at least one processor and at least one non-transitory memory including computer program instructions stored therein, the computer program code instructions configured to, when executed, cause the apparatus to at least: aggregate observations and vehicle paths from sensor data from one or more data sources; determine observation counts for each of the one or more data sources; collapse aggregated vehicle paths onto road topology by travel direction; assign the observation counts to a nearest road topology; project an observation count for each of the one or more data sources along a predetermined distance unit of the road topology to form observation intervals along the road topology, each observation interval including a respective observation count; iterate over the road topology using the observation intervals and their respective observation counts; and determine a value of the sensor data based on lengths of the observation intervals and their respective observation counts.

According to some embodiments, in response to the observation intervals along the road topology overlapping, the apparatus is caused to supersede an observation interval having a lower observation count with an overlapping portion of an observation interval having a higher observation count. According to certain embodiments, causing the apparatus to supersede an observation interval having a lower observation count with an overlapping portion of an observation interval having a higher observation count includes causing the apparatus to reduce a length of the observation interval having the lower observation count by a length of the overlapping portion.

The apparatus of an example embodiment is further caused to determine, for a respective one of the one or more data sources, a value of the sensor data provided by the respective one of the one or more data sources. The apparatus of certain embodiments is further caused to provide for compensation to the respective one of the one or more data sources based on the value of the sensor data. According to some embodiments, causing the apparatus to collapse aggregated vehicle paths to road topology by travel direction includes causing the apparatus to merge redundant co-directed vehicle paths. According to certain embodiments, in response to a respective observation interval of the observation intervals extending through an intersection, divide the respective observation count of the respective observation interval between road topology intersecting at the intersection.

Embodiments provided herein include a computer program product including at least one non-transitory computer-readable storage medium having computer-executable program code instructions stored therein, the computer-executable program code instructions including program code instructions to: aggregate observations and vehicle paths from sensor data from one or more data sources; collapse aggregated vehicle paths to road topology by travel direction; assign the observation counts to a nearest road topology; project an observation count for each of the one or more data sources along a predetermined distance unit of the road topology to form observation intervals along the road topology, each observation interval including a respective observation count; iterate over the road topology using the observation intervals to establish, for lengths of the road topology, observation intervals and their respective observation counts; and determine a value of the sensor data based on lengths of the observation intervals and their respective observation counts.

According to certain embodiments, in response to the observation intervals along the road topology overlapping, the computer program product further includes program code instructions to supersede an observation interval having a lower observation count with an overlapping portion of an observation interval having a higher observation count. The program code instructions to supersede an observation interval having a lower observation count with an overlapping portion of an observation interval having a higher observation count includes, in some embodiments, program code instructions to reduce a length of the observation interval having the lower observation count by a length of the overlapping portion.

The computer program product of some embodiments includes program code instructions to determine, for a respective one of the one or more data sources, a value of the sensor data provided by the respective one of the one or more data sources. The computer program product of some embodiments includes program code instructions to provide for compensation to the respective one of the one or more data sources based on the value of the sensor data. The program code instructions to collapse aggregated vehicle paths to road topology by travel direction includes, in some embodiments, program code instructions to merge redundant, co-directed vehicle paths. In response to a respective observation interval of the observation intervals extending through an intersection, the computer program product of an example embodiment includes program code instructions to divide the respective observation count of the respective observation interval between road topology intersecting at the intersection.

Embodiments provided herein include a method, including: aggregating observations and vehicle paths from sensor data from one or more data sources; determining observation counts for each of the one or more data sources; collapsing aggregated vehicle paths to road topology by travel direction; assigning the observation counts to a nearest road topology; projecting an observation count for each of the one or more data sources along a predetermined distance unit of the road topology to form observation intervals along the road topology, each observation interval including a respective observation count; iterating over the road topology using the observation intervals to establish, for lengths of the road topology, observation intervals and their respective observation counts; and determining a value of the sensor data based on lengths of the observation intervals and their respective observation counts.

According to some embodiments, in response to the observation intervals along the road topology overlapping, superseding an observation interval having a lower observation count with an overlapping portion of an observation having a higher observation count. According to certain embodiments, superseding an observation interval having a lower observation count with an overlapping portion of an observation interval having a higher observation count includes reducing a length of the observation interval having the lower observation count by a length of the overlapping portion. Methods of some embodiments include determining, for a respective one of the one or more data sources, a value of the sensor data provided by the respective one of the one or more data sources. According to some embodiments, the method includes providing for compensation to the respective one of the one or more data sources based on the value of the sensor data. According to certain embodiments, collapsing aggregated vehicle paths to road topology by travel direction includes merging redundant co-directed vehicle paths.

Embodiments provided herein include an apparatus, including: means for aggregating observations and vehicle paths from sensor data from one or more data sources; means for determining observation counts for each of the one or more data sources; means for collapsing aggregated vehicle paths to road topology by travel direction; means for assigning the observation counts to a nearest road topology; means for projecting an observation count for each of the one or more data sources along a predetermined distance unit of the road topology to form observation intervals along the road topology, each observation interval including a respective observation count; means for iterating over the road topology using the observation intervals to establish, for lengths of the road topology, observation intervals and their respective observation counts; and means for determining a value of the sensor data based on lengths of the observation intervals and their respective observation counts.

According to some embodiments, in response to the observation intervals along the road topology overlapping, the apparatus includes means for superseding an observation interval having a lower observation count with an overlapping portion of an observation having a higher observation count. According to certain embodiments, the means for superseding an observation interval having a lower observation count with an overlapping portion of an observation interval having a higher observation count includes means for reducing a length of the observation interval having the lower observation count by a length of the overlapping portion. The apparatus of some embodiments includes means for determining, for a respective one of the one or more data sources, a value of the sensor data provided by the respective one of the one or more data sources. According to some embodiments, the apparatus includes means for providing for compensation to the respective one of the one or more data sources based on the value of the sensor data. According to certain embodiments, the means for collapsing aggregated vehicle paths to road topology by travel direction includes means for merging redundant co-directed vehicle paths.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 is a block diagram of an apparatus according to an example embodiment of the present disclosure;

FIG. 2 is a block diagram of a system for generating sensor data usage statistics according to an example embodiment of the present disclosure;

FIG. 3 illustrates vehicle paths of an intersection according to an example embodiment of the present disclosure;

FIG. 4 illustrates the vehicle paths of the intersection of FIG. 3 collapsed onto the road topology according to an example embodiment of the present disclosure;

FIG. 5 illustrates an example embodiment of a road network graph of road topology that includes a maximum observation count per source along a distance unit of one kilometer according to an example embodiment of the present disclosure;

FIG. 6 illustrates how, when observation intervals overlap, the maximum observation count is recorded and the lower observation count observation interval is shortened according to an example embodiment of the present disclosure;

FIG. 7 illustrates an example embodiment of architecture specifically configured for implementing embodiments described herein according to an example embodiment of the present disclosure; and

FIG. 8 illustrates a method for generating sensor data usage statistics according to an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A method, apparatus and computer program product are provided in accordance with an example embodiment of the present disclosure for attribution of sensor data along roads of a road network, and more particularly, to analyzing sensor data from roads of the road network to monitor sensor data usage, which can in turn be used for value estimation and compensation for data usage. Autonomous vehicles leverage sensor information relating to roads and objects and features proximate the roads to determine safe regions of a road to drive and to evaluate their surroundings as they traverse a road segment. Further, autonomous and semi-autonomous vehicles use high-definition map information to facilitate autonomous driving and to plan autonomous driving routes. These high-definition maps or HD maps are specifically designed and configured to facilitate autonomous and semi-autonomous vehicle control and may be able to replicate road segments virtually with the inclusion of accurately placed signs and other features or objects proximate a roadway.

HD maps have a high precision at resolutions that may be down to several centimeters that identify objects proximate a road segment, such as features of a road segment including lane widths, lane markings, traffic direction, speed limits, lane restrictions, etc. Autonomous and semi-autonomous vehicles use these HD maps to facilitate the autonomous control features, such as traveling within a lane of a road segment at a prescribed speed limit. Autonomous vehicles may also be equipped with a plurality of sensors to facilitate autonomous vehicle control. Sensors may include image sensors/cameras, Light Distancing and Ranging (LiDAR), Global Navigation Satellite Systems (GNSS) such as Global Positioning Systems (GPS), Galileo etc., Inertial Measurement Units (IMUs), or the like which may measure the surroundings of a vehicle and communicate information regarding the surroundings to a vehicle control module to process and adapt vehicle control accordingly.

HD maps may be generated and updated based on sensor data from sensor-equipped vehicles traveling along road segments of a road network. These vehicles may have various degrees of autonomy and may be equipped with a variety of different levels of sensors. Sensors from fully autonomous vehicles, for example, may be used to update map data or generate new map data in a form of crowd-sourced data from vehicles traveling along road segments. Sensor data received can be aggregated with other sensor data relating to the data captured by sensors to establish the accuracy of sensor data and to confirm the position, size, shape, etc. of features and objects along the road segment.

Sensor data gathered by vehicles along road segments of a road network has value, and the generation and publishing of such data for services such as location-based services can be leveraged for compensation for the collected data. Device and software manufacturers can collect sensor data from vehicles traveling within a road network; however, this gathering of data is expensive and thus benefits from compensation for the collected data when it is shared with data consumers. Given the ubiquity of highly-capable sensor suites on vehicles traveling within a road network, and given the millions of miles of roads around the world, the volume of sensor data collected is vast, and fairly compensating a data provider for useful data is challenging. Embodiments described herein provide a method of estimating sensor data usage that is fair but does not require an exact accounting of usage. Embodiments do not require explicit traceability from high volume data sources resulting in increased scalability and reduced cost, while fairly compensating data sources.

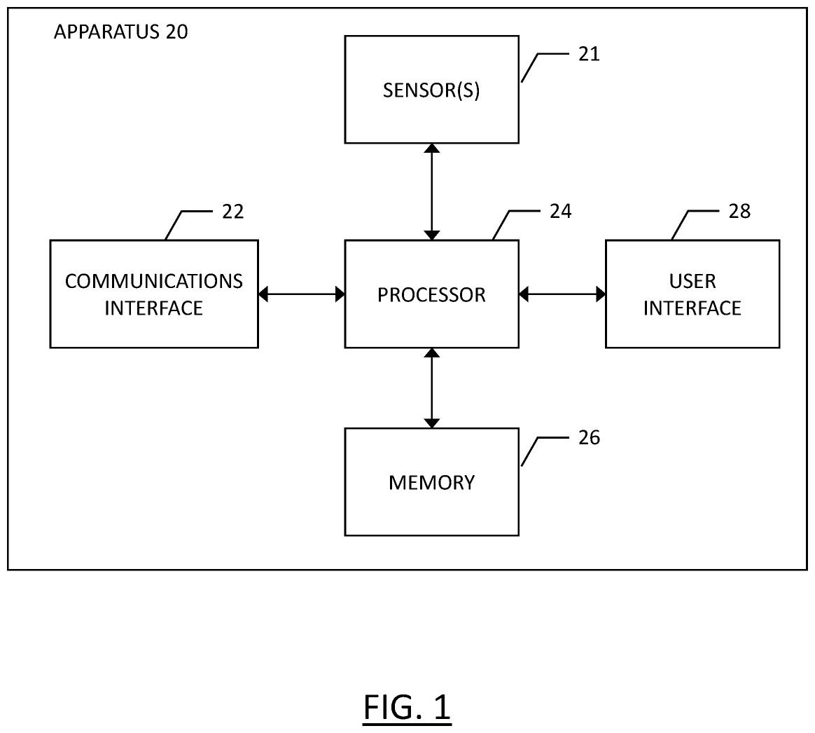

FIG. 1 is a schematic diagram of an example apparatus configured for performing any of the operations described herein. Apparatus 20 is an example embodiment that may be embodied by or associated with any of a variety of computing devices that include or are otherwise associated with a device configured for providing advanced driver assistance features which may include a navigation system user interface. For example, the computing device may be an Advanced Driver Assistance System module (ADAS) which may at least partially control autonomous or semi-autonomous features of a vehicle. However, as embodiments described herein may optionally be used for map generation, map updating, and map accuracy confirmation, embodiments of the apparatus may be embodied or partially embodied as a mobile terminal, such as a personal digital assistant (PDA), mobile telephone, smart phone, personal navigation device, smart watch, tablet computer, camera or any combination of the aforementioned and other types of voice and text communications systems. In a preferred embodiment where some level of vehicle autonomy is involved, the apparatus 20 is embodied or partially embodied by an electronic control unit of a vehicle that supports safety-critical systems such as the powertrain (engine, transmission, electric drive motors, etc.), steering (e.g., steering assist or steer-by-wire), and braking (e.g., brake assist or brake-by-wire). Optionally, the computing device may be a fixed computing device, such as a built-in vehicular navigation device, assisted driving device, or the like.

Optionally, the apparatus may be embodied by or associated with a plurality of computing devices that are in communication with or otherwise networked with one another such that the various functions performed by the apparatus may be divided between the plurality of computing devices that operate in collaboration with one another.

The apparatus 20 may be equipped or associated, e.g., in communication, with any number of sensors 21, such as a global positioning system (GPS), accelerometer, an image sensor, LiDAR, radar, and/or gyroscope. Any of the sensors may be used to sense information regarding the movement, positioning, or orientation of the device for use in navigation assistance, as described herein according to example embodiments. In some example embodiments, such sensors may be implemented in a vehicle or other remote apparatus, and the information detected may be transmitted to the apparatus 20, such as by near field communication (NFC) including, but not limited to, Bluetooth™ communication, or the like.

The apparatus 20 may include, be associated with, or may otherwise be in communication with a communication interface 22, a processor 24, a memory device 26 and a user interface 28. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The processor 24 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 24 may be configured to execute instructions stored in the memory device 26 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, the computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 20 of an example embodiment may also include or otherwise be in communication with a user interface 28. The user interface may include a touch screen display, a speaker, physical buttons, and/or other input/output mechanisms. In an example embodiment, the processor 24 may comprise user interface circuitry configured to control at least some functions of one or more input/output mechanisms. The processor and/or user interface circuitry comprising the processor may be configured to control one or more functions of one or more input/output mechanisms through computer program instructions (for example, software and/or firmware) stored on a memory accessible to the processor (for example, memory device 24, and/or the like).

The apparatus 20 of an example embodiment may also optionally include a communication interface 22 that may be any means such as a device or circuitry embodied in either hardware or a combination of hardware and software that is configured to receive and/or transmit data from/to other electronic devices in communication with the apparatus, such as by NFC, described above. Additionally or alternatively, the communication interface 22 may be configured to communicate over Global System for Mobile Communications (GSM), such as but not limited to Long Term Evolution (LTE). In this regard, the communication interface 22 may include, for example, an antenna (or multiple antennas) and supporting hardware and/or software for enabling communications with a wireless communication network. Additionally or alternatively, the communication interface 22 may include the circuitry for interacting with the antenna(s) to cause transmission of signals via the antenna(s) or to handle receipt of signals received via the antenna(s). In some environments, the communication interface 22 may alternatively or also support wired communication and/or may alternatively support vehicle to vehicle or vehicle to infrastructure wireless links.

The apparatus 20 may support a mapping or navigation application so as to present maps or otherwise provide navigation or driver assistance. For example, the apparatus 20 may provide for display of a map and/or instructions for following a route within a network of roads via user interface 28. In order to support a mapping application, the computing device may include or otherwise be in communication with a geographic database, such as may be stored in memory 26. For example, the geographic database includes node data records, road segment or link data records, point of interest (POI) data records, and other data records. More, fewer or different data records can be provided. In one embodiment, the other data records include cartographic data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example. Furthermore, other positioning technology may be used, such as electronic horizon sensors, radar, LiDAR, ultrasonic and/or infrared sensors.

In example embodiments, a navigation system user interface may be provided to provide driver assistance to a user traveling along a network of roadways. Optionally, embodiments described herein may provide assistance for autonomous or semi-autonomous vehicle control. Autonomous vehicle control may include driverless vehicle capability where all vehicle functions are provided by software and hardware to safely drive the vehicle along a path identified by the vehicle. Semi-autonomous vehicle control may be any level of driver assistance from adaptive cruise control, to lane-keep assist, or the like. Identifying objects along road segments or road links that a vehicle may traverse may provide information useful to navigation and autonomous or semi-autonomous vehicle control by establishing barriers defining roadway width, identifying roadway curvature, or any boundary related details of the road links that may be traversed by the vehicle.

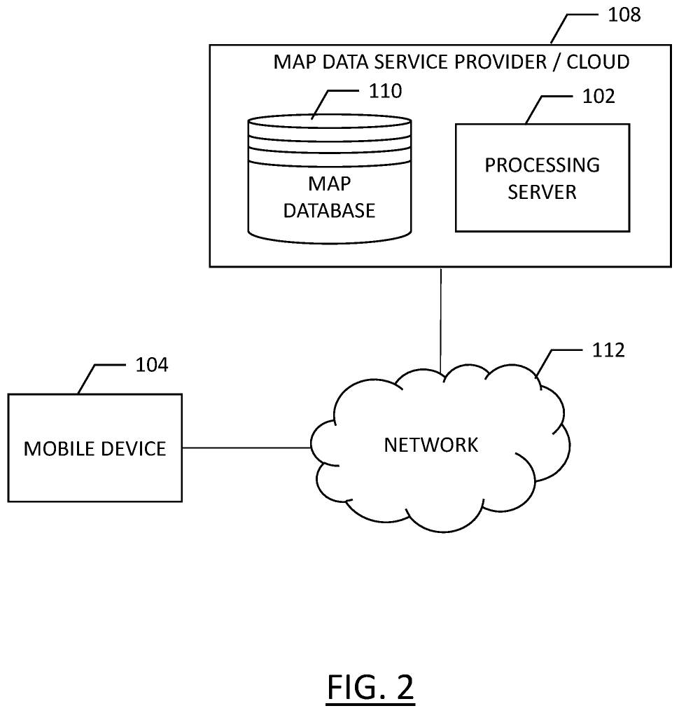

A map service provider database may be used to provide driver assistance via a navigation system and/or through an ADAS having autonomous or semi-autonomous vehicle control features. FIG. 2 illustrates a communication diagram of an example embodiment of a system for implementing example embodiments described herein. The illustrated embodiment of FIG. 2 includes a mobile device 104, which may be, for example, the apparatus 20 of FIG. 2, such as a mobile phone, an in-vehicle navigation system, an ADAS, or the like, and a map data service provider or cloud service 108. Each of the mobile device 104 and map data service provider 108 may be in communication with at least one of the other elements illustrated in FIG. 2 via a network 112, which may be any form of wireless or partially wireless network as will be described further below. Additional, different, or fewer components may be provided. For example, many mobile devices 104 may connect with the network 112. The map data service provider 108 may be cloud-based services and/or may operate via a hosting server that receives, processes, and provides data to other elements of the system.

The map data service provider may include a map database 110 that may include node data, road segment data or link data, point of interest (POI) data, traffic data or the like. The map database 110 may also include cartographic data, routing data, and/or maneuvering data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities. Optionally, the map database 110 may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 110 can include data about the POIs and their respective locations in the POI records. The map database 110 may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 110 can include event data (e.g., traffic incidents, construction activities, scheduled events, unscheduled events, etc.) associated with the POI data records or other records of the map database 110.

The map database 110 may be maintained by a content provider e.g., the map data service provider and may be accessed, for example, by the content or service provider processing server 102. By way of example, the map data service provider can collect geographic data and dynamic data to generate and enhance the map database 110 and dynamic data such as traffic-related data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LiDAR, can be used to generate map geometries directly or through machine learning as described herein. However, the most ubiquitous form of data that may be available is vehicle data provided by vehicles, such as mobile device 104, as they travel the roads throughout a region.

The map database 110 may be a master map database, such as an HD map database, stored in a format that facilitates updates, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device 104, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the map data service provider 108 map database 110 may be a master geographic database, but in alternate or complementary embodiments, a client side map database may represent a compiled navigation database that may be used in or with end user devices (e.g., mobile device 104) to provide navigation and/or map-related functions. For example, the map database 110 may be used with the mobile device 104 to provide an end user with navigation features. In such a case, the map database 110 can be downloaded or stored on the end user device which can access the map database 110 through a wireless or wired connection, such as via a processing server 102 and/or the network 112, for example.

As noted above, the map database 110 of example embodiments may be generated from a plurality of different sources of data. The data stored in the map database may be gathered from multiple different sources, and one source of data that may help keep the data in the map database fresh is map data provided by vehicles traveling along the road segments of the road network.

While municipalities and businesses may provide map data to a map database, this data may not be up-to-date, may be incomplete, or may be inaccurate. The ubiquity with which vehicles travel along road segments render those vehicles as opportunities to collect data related to the road segments provided the vehicles are equipped with some degree of sensor technology. A vehicle traveling along a road segment with only location sensing technology, such as a Global Navigation Satellite System like GPS, Galileo, etc., may provide data relating to the path of a road segment, while vehicles with more technologically advanced sensors may be able to provide additional information. Sensor data from image sensors or depth sensors such as LiDAR may provide details regarding the features of road segments including the position of signs along the road segment and the information contained on the signs.

Sensor data from vehicles traveling within a road network may gathered by device manufacturers and software providers. For example, a vehicle manufacturer or OEM (original equipment manufacturer) can gather sensor data from vehicles they have made. Similarly, device manufacturers such as mobile devices, cell phones, navigation systems, etc. can gather sensor data from vehicles as they traverse a road network. Software providers, such as those that make mapping software or navigation aids can also gather sensor data in some embodiments. Each of these sources can gather data from vehicles and amass vast troves of sensor data from a road network. This sensor data can e anonymized to remove association with any individual vehicles, thereby preserving privacy of an individual which may be required by laws or by user agreements, for example. This crowd-sourced data can be used by service providers to build more robust and reliable maps with a greater level of detail than previously available. Further, beyond building the maps in the map database 110, sensor data may be used to update map data or confirm existing map data to ensure the map database 110 is maintained and as up-to-date as possible. The accuracy and freshness of map data may be critical as vehicles become more advanced and autonomous control of vehicles becomes more ubiquitous as the map database 110 may provide information that facilitates control of a vehicle along a road segment.

To appropriately compensate data providers, such as OEMs, device manufacturers, and software providers, a system is provided herein to enable the attribution of data to a source and to account for usage of the data. The estimates of usage provided by embodiments described herein do not require explicit traceability from these high-volume data sources such that the process is efficient and scalable with vast amounts of sensor data.

Map maintenance using sensor data is complex given the high volume of sensor data used to update a map of observable features without requiring explicit traceability to each source observation or drive within the road network. Embodiments described herein can estimate data usage in map building and healing that can be used to provide reports for billing for data usage, insights for data sourcing and costs, and when coupled with quality measures, can inform cost of sources required to achieve different quality levels of map data. Sensor data from a road network can be used by service providers on the basis of distance units. A distance unit may be, for example, a kilometer, such that the amount of sensor data used can be a number of observations over that distance unit, such as ten observed objects over one kilometer. The sensor data can be paid for on a per distance unit basis.

Embodiments described herein aggregate drive paths from multiple sources. The aggregated drive paths are collapsed into a road topology model with observation counts projected for aggregated features on the road topology model. The sensor data usage can be estimated by summing the counts projected onto the road topology in units of source distance units used.

Observations and vehicle paths from all sensor data sources can be aggregated while tracking observation counts from each data source. Observations include the identification of an object and properties associated with the object. For example, discrete objects such as signs, poles, or other objects that have discrete locations can be observed, and features of the observation included within the observation, such as a sign type, sign content, sign shape, pole size, etc.

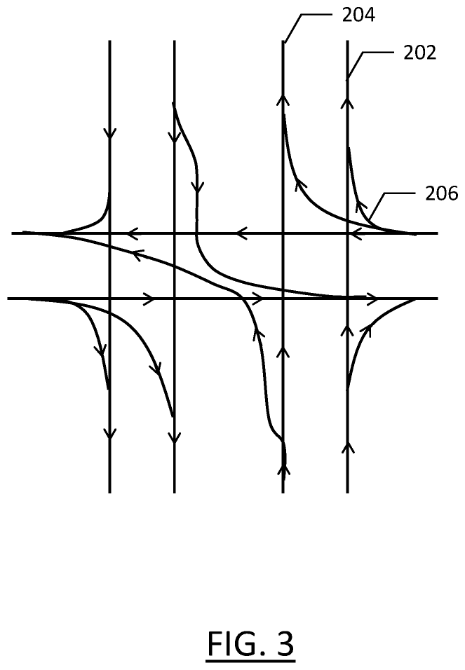

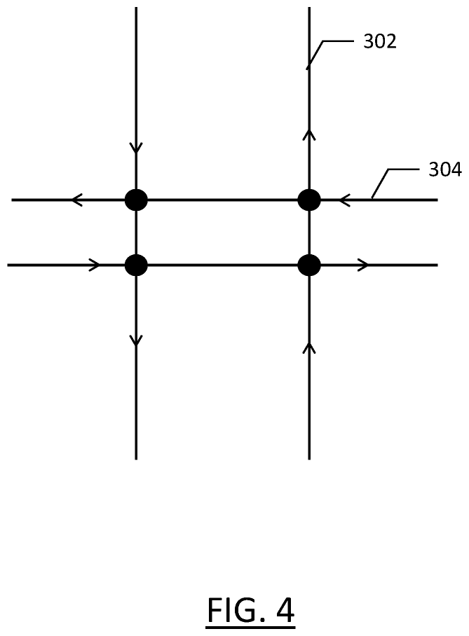

To improve the efficiency with which the observations are processed, aggregated vehicle paths from individual drives are collapsed from lane topology and maneuvers to road topology based on travel direction. FIG. 3 illustrates an example intersection in a road network with lane topology and turn maneuvers included. As shown, there are individual lanes 202 and 204, along with turn maneuvers such as turn maneuver 206 for a plurality of drives among a road network. FIG. 4 depicts the lane topology and turn maneuvers collapsed to road topology by travel direction, where adjacent co-directed paths have been merged such as to road segments 302 and 304, and redundant turn maneuvers at the intersections have been removed. The directed road network of FIG. 4 is used in embodiments described herein such that sensor data processing and attribution is efficient and effective.

Observations from each individual drive are assigned with counts parametrically to the nearest topology. Lane marking and continuous object observations are sampled at a configurable distance, such as at 500 meters. This distance may be selected as half of the distance unit described above, whereby observations are “painted” onto a road segment for half of the distance unit before the observation location, and half of the distance unit after the observation location. Discrete objects are aligned with the nearest topology as the discrete location for the observed object. For all observations, the maximum observation count on a per-source basis is projected or painted on the road topology for a distance unit of the road segment as noted above, with half preceding the observation, and half after the observation in the direction of travel. The distance unit, as noted above, may be a kilometer, for example. The observation count on a per source basis would be painted forwards and backwards half of the distance unit (e.g., 500 meters) from the observation.

The observation count can also be painted to branches off of the road segment. At junctions or intersections, a maximum value of observations for a road segment may be split among the road segments leaving the junction. The observation counts can thus be fractional when an observation is split over different road segments. If a number of drives that contributed to the road network graph from the lane network graph from each data provider is available, this information can be used to calculate a more precise weighting for the distribution of observations through an intersection. For example, if a less traveled road branches off from a main road, a proportional allocation of observations may be provided to the less traveled road based on the proportion of vehicles that turn from the main road onto the less traveled road. Optionally, road functional classifications can be used to establish proportionality of division of observations through intersections. Roads with a greater functional classification (e.g., highways, expressways, etc.) may be proportionally weighted more heavily than a lower functional classification (e.g., local roads).

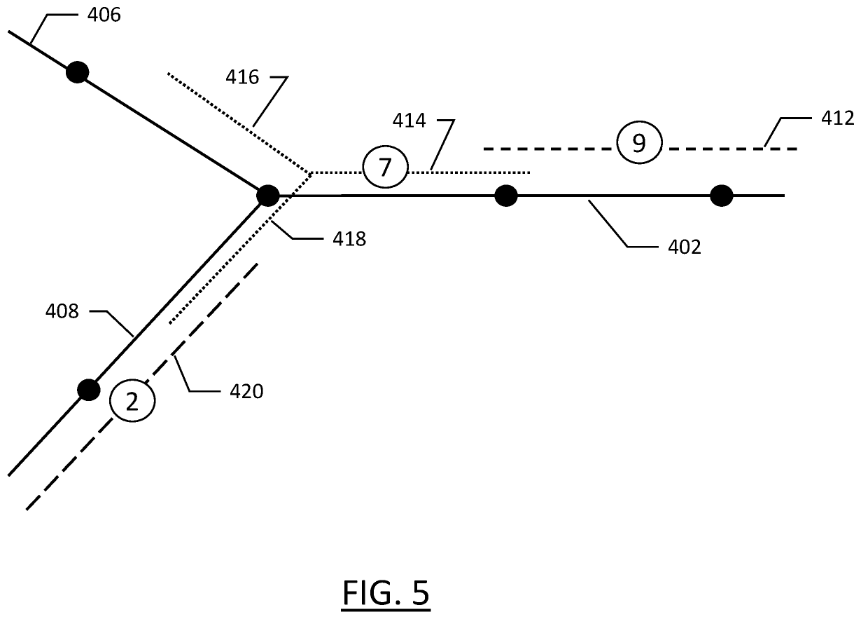

FIG. 5 illustrates an example embodiment of a road network graph of road topology that includes a maximum observation count per source along a distance unit of one kilometer. As shown, the road topology includes a main road 402 that is split at an intersection into a first split road 406 and second split road 408. Vehicles traversing the road network generate sensor data including observations. The observations are propagated in either direction along a road link from the nearest point on the nearest road link. For a distance unit of one kilometer, the observations are propagated 500 meters in either direction.

The observation intervals are depicted in FIG. 5, with each different type of dashed line reflecting a different observation interval. The observation interval is the length of the road topology along which an observation is painted or projected The number of observations for each observation interval is shown in the circle over the respective observation interval. For example, observation interval 412 is formed by twelve observations. Observation interval 414 is formed by seven observations. Observation interval 414 is split into first split road 406 observation interval 416 and second split road 408 observation interval 418. Here, the observations from observation interval 414 may be split over the split road observation intervals. For example, first split road 406 observation interval 416 may be designated to have 3.5 observations and second split road 408 observation interval 418 may also be designated to have 3.5 observations. The splitting of the observations can be performed based on traffic patterns (e.g., weighted based on traffic volumes), road classes, or the like. Finally observation interval 420 has two observations.

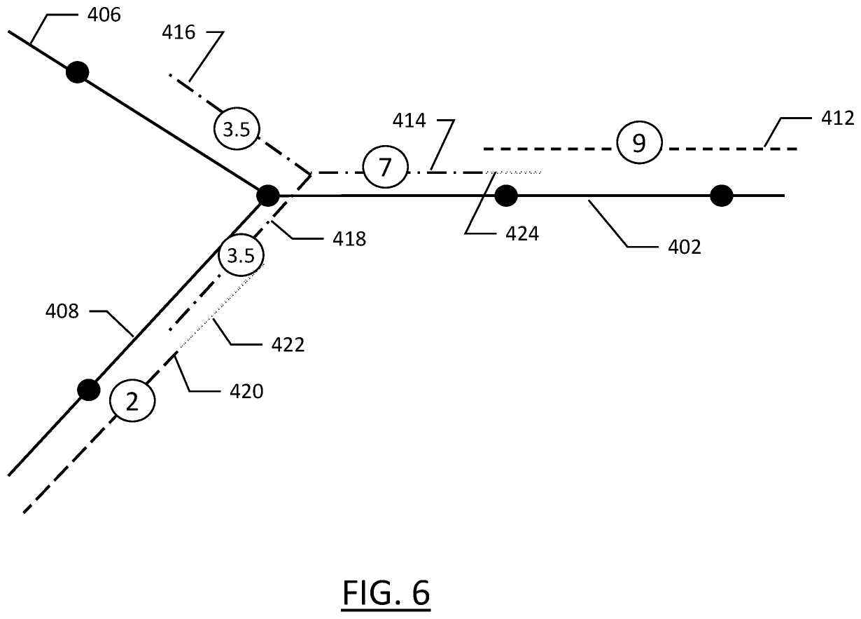

FIG. 6 illustrates how, when observation intervals overlap, the maximum observation count is recorded and the lower observation count observation interval is shortened. As shown, with observation interval 412 having nine observations, and observation interval 414 having seven observations, portion 424 of observation interval 424 is superseded. Similarly, observation interval 420 only having two observations is superseded by second road split 408 observation interval 418 for portion 422 of observation interval 420.

The observation intervals are iterated over the map to establish the sensor data associated with observation intervals of the roads. For each observation count interval, the maximum observation count multiplied by the length of the observation interval is used to create an estimate of the value of the sensed data. That estimate of the value is added to estimates from all road segments of the road network or from a specific geographic area to identify a total value of the sensed data for that road network or specific geographic area. This value can be used as the cost of the sensor data that is provided to the service provider.

Embodiments of the present disclosure do not require explicit traceability from the high volume sources such as the OEMs, device manufacturers, and software providers, resulting in increased scalability and reduced cost. This estimate of usage is intended to be fair, but is not an exact accounting of the usage of the sensor data gathered.

For example, embodiments can be an underestimation, where an ideal operation assumes all drives contain at least one feature per kilometer for the count of observations to be high. If five drives observe a sign on the left, and five drives observe a sign on the right, the count should be ten observations, but the count of embodiments provided herein would be five. Using a sum of the observations would result generally in overestimation while an average would be much lower than the summed observation count. Embodiments described herein can also be an overestimation, as the algorithm described herein estimates the impact of even one feature to be no less than a predefined distance unit, such as one kilometer. The precision at junctions of embodiments described herein can be low when it assumes all potential routes are taken equally (e.g., a split at an intersection divides observations in two). Further embodiments can use statistics on the underlying road graph to more accurately estimate the distribution of drives at junctions to more appropriately apportion the observations.

The aforementioned examples use a predefined distance of one kilometer, where the impact of an observation is presumed to be 500 meters before and after the observation. The observation is painted 500 meters bac, and 500 meters forward. However, this 500 meters is tunable. Using a shorter distance may result in more accurate sensor data observation counts and alter the calculated value. However, using a shorter distance requires more processing capacity and bandwidth, such that there is a tradeoff. The predefined distance of one kilometer tends to have an acceptable level of estimation for purposes described herein.

As described above, HD maps may be instrumental in facilitating autonomous vehicle control. Building the HD maps may rely on sensor data received from crowd sourced detectors including image sensors and depth detectors (e.g., LiDAR) from vehicles traveling along the network of roads that is mapped. The sensor data that is received is processed to identify objects and features in the sensor data to properly build and update the HD maps, and to facilitate autonomous control of the vehicle generating the sensed data. Embodiments provided herein use sensor data to generate sensor data usage statistics for billing. The vast volume of sensor data from vehicles traveling within the millions of miles of roads is challenging to process; however, embodiments described herein improve upon the functioning of a map service provider computer by processing sensor data in a manner that does not require explicit traceability from high volume data sources such that the process can be scaled while improving efficiency and reducing cost.

According to example embodiments described herein, the role of HD maps in facilitating autonomous or semi-autonomous vehicle control may include crowd-sourced building of the maps to identify and confirm features of the maps and their respective locations. In the context of map-making, the features from the environment may be detected by a vehicle traveling along a road segment and consolidated to form a representation of the actual real-world environment in the form of a map. Embodiments described herein include a method, apparatus, and computer program product to compensate the source of such sensor data in a manner that reflects the contributions of the data source through efficient sensor data processing and alignment with the road topography.

Vehicles traveling along a road segment may be equipped with sensors, such as sensors 21 of apparatus 20 of FIG. 1, where the sensors may include image sensors and distance sensors (e.g., LiDAR sensor or other three-dimensional sensor). These sensors may be used to detect features of an environment to facilitate autonomous and semi-autonomous driving. The sensors may be part of a detection module or perception module which may feature a plurality of sensors to obtain a full interpretation of the environment of the module and the vehicle associated therewith. OEMs, device manufacturers, and software providers can gather this data and provide the sensor data to a service provider that can generate and heal digital maps of the environment.

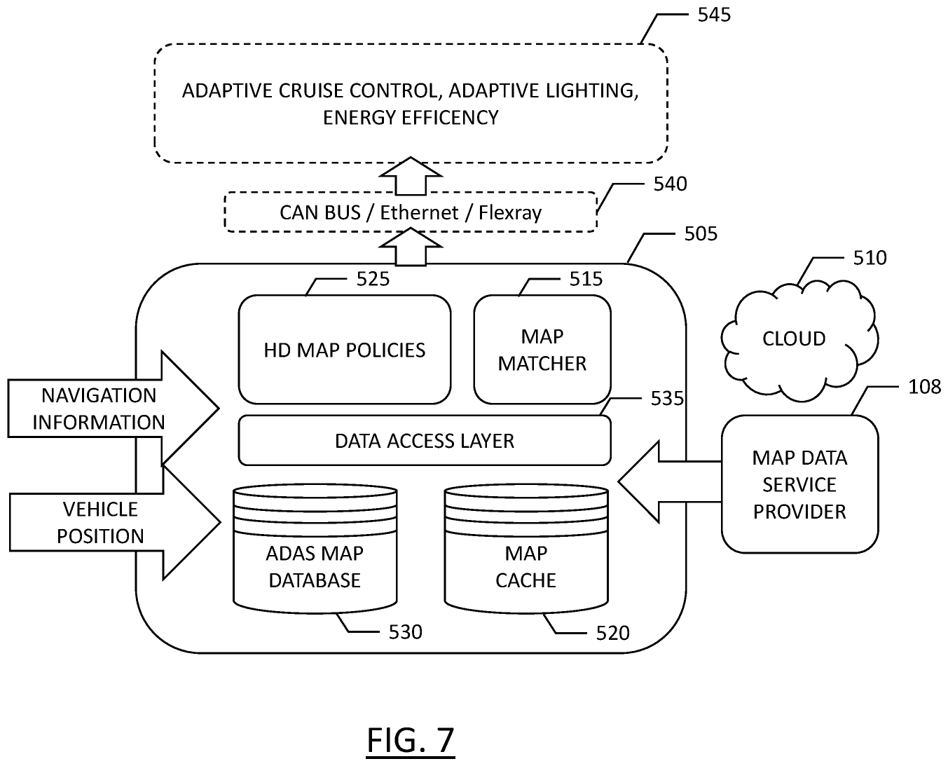

FIG. 7 illustrates an example embodiment of architecture specifically configured for implementing embodiments described herein. The illustrated embodiment of FIG. 6 may be vehicle-based, where sensor data is obtained from sensors of a vehicle traveling along a road segment. The location of the collected sensor data along the road segment may be determined through location determination using GPS or other positioning means and correlated to map data of map data service provider 108. As illustrated, the architecture includes a map data service provider 108 that provides map data (e.g., HD maps and policies associated with road links within the map) to the Advanced Driver Assistance System (ADAS) 505, which may be vehicle-based or server based depending upon the application. The map data service provider may be a cloud-based 510 service. The ADAS receives navigation information and vehicle position and may use that information to map-match 515 the position to a road link on a map of the mapped network of roads stored in the map cache 520. This link or segment, along with the direction of travel, may be used via data access layer 535 to establish which HD map policies are applicable to the vehicle associated with the ADAS, including sensor capability information, autonomous functionality information, etc. Accordingly, policies for the vehicle are established based on the current location and the environmental conditions (e.g., traffic, time of day, weather). The HD map policies associated with the road segment specific to the vehicle are provided to the vehicle control, such as via the CAN (computer area network) BUS (or Ethernet or Flexray) 540 to the electronic control unit (ECU) 545 of the vehicle to implement HD map policies, such as various forms of autonomous or assisted driving, or navigation assistance.

A vehicle traveling along a road segment may receive sensor data from a plurality of sensors used to capture data relating to the surrounding environment, such as the position of an object (e.g., a sign, pole, lane markings, road barriers, etc.) relative to a vehicle and the road segment. These geospatial observations may be generated along discrete trajectories that are aligned and used to definitively identify the geo-location of objects within a map database. The automatic building and updating of map geometries as described herein can produce accurate HD maps with great efficiency. Further, embodiments provide a mechanism by which data sources of the sensor data that supply map service providers with the sensor data are fairly compensated for the sensor data they provide, thereby encouraging the gathering and sharing of this sensor data.

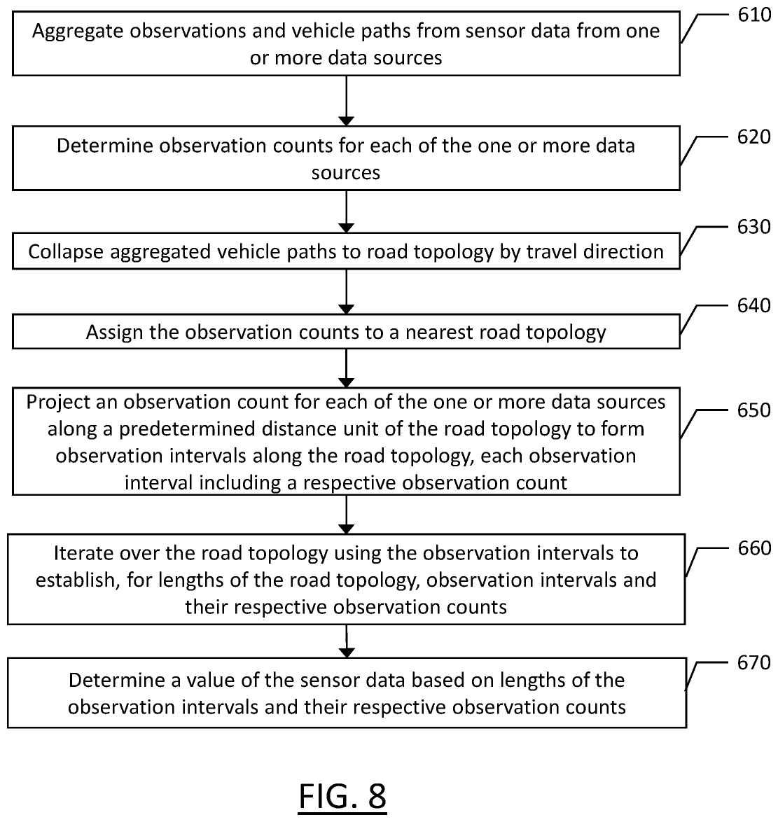

FIG. 8 illustrates a flowchart depicting a method according to an example embodiment of the present invention. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 26 of an apparatus employing an embodiment of the present invention and executed by a processor 24 of the apparatus 20. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

FIG. 8 is a flowchart of a method for analyzing sensor data from roads of the road network to monitor sensor data usage, which can in turn be used for value estimation and compensation for data usage. As shown, at 610 observations and vehicle paths from sensor data from one or more data sources are aggregated. Observation counts are determined at 620 for each of the one or more data sources. Aggregated vehicle paths are collapsed onto road topology by travel direction at 630. The observation counts are assigned at 640 to a nearest road topology. At 650, an observation count is projected for each of the one or more data sources along a predetermined distance unit of the road topology to form observation intervals along the road topology, each observation interval including a respective observation count. The observation intervals are used to iterate over the road topology at 660 to establish, for lengths of the road topology, observation intervals and their respective observation counts. At 670 a value of the sensor data is determined based on lengths of the observation intervals and their respective observation counts.

In an example embodiment, an apparatus for performing the method of FIG. 7 above may comprise a processor (e.g., the processor 24) configured to perform some or each of the operations (610-670) described above. The processor may, for example, be configured to perform the operations (610-670) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 610-670 may comprise, for example, the processor 24 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one non-transitory memory including computer program code instructions, the computer program code instructions configured to, when executed, cause the apparatus to at least:
aggregate observations and vehicle paths from sensor data from one or more data sources;
determine observation counts for each of the one or more data sources;
collapse aggregated vehicle paths to road topology by travel direction;
assign the observation counts to a nearest road topology;
project an observation count for each of the one or more data sources along a predetermined distance unit of the road topology to form observation intervals along the road topology, each observation interval comprising a respective observation count;
iterate over the road topology using the observation intervals to establish, for lengths of the road topology, observation intervals and their respective observation counts; and
determine a value of the sensor data based on lengths of the observation intervals and their respective observation counts.

2. The apparatus of claim 1, wherein in response to the observation intervals along the road topology overlapping, the apparatus is caused to supersede an observation interval having a lower observation count with an overlapping portion of an observation interval having a higher observation count.

3. The apparatus of claim 2, wherein causing the apparatus to supersede an observation interval having a lower observation count with an overlapping portion of an observation interval having a higher observation count comprises causing the apparatus to reduce a length of the observation interval having the lower observation count by a length of the overlapping portion.

4. The apparatus of claim 1, wherein the apparatus is further caused to determine, for a respective one of the one or more data sources, a value of the sensor data provided by the respective one of the one or more data sources.

5. The apparatus of claim 4, wherein the apparatus is further caused to provide for compensation to the respective one of the one or more data sources based on the value of the sensor data.

6. The apparatus of claim 1, wherein causing the apparatus to collapse aggregated vehicle paths to road topology by travel direction comprises causing the apparatus to merge redundant co-directed vehicle paths.

7. The apparatus of claim 1, wherein in response to a respective observation interval of the observation intervals extending through an intersection, cause the apparatus to divide the respective observation count of the respective observation interval between road topology intersecting at the intersection.

8. A computer program product comprising at least one non-transitory computer-readable storage medium having computer-executable program code instructions stored therein, the computer-executable program code instructions comprising program code instructions to:
aggregate observations and vehicle paths from sensor data from one or more data sources;
determine observation counts for each of the one or more data sources;
collapse aggregated vehicle paths to road topology by travel direction;
assign the observation counts to a nearest road topology;
project an observation count for each of the one or more data sources along a predetermined distance unit of the road topology to form observation intervals along the road topology, each observation interval comprising a respective observation count;
iterate over the road topology using the observation intervals to establish, for lengths of the road topology, observation intervals and their respective observation counts; and
determine a value of the sensor data based on lengths of the observation intervals and their respective observation counts.

9. The computer program product of claim 8, wherein in response to the observation intervals along the road topology overlapping, the computer program product further comprises program code instructions to supersede an observation interval having a lower observation count with an overlapping portion of an observation interval having a higher observation count.

10. The computer program product of claim 9, wherein the program code instructions to supersede an observation interval having a lower observation count with an overlapping portion of an observation interval having a higher observation count comprise program code instructions to reduce a length of the observation interval having the lower observation count by a length of the overlapping portion.

11. The computer program product of claim 8, further comprising program code instructions to determine, for a respective one of the one or more data sources, a value of the sensor data provided by the respective one of the one or more data sources.

12. The computer program product of claim 11, further comprising program code instructions to provide for compensation to the respective one of the one or more data sources based on the value of the sensor data.

13. The computer program product of claim 8, wherein the program code instructions to collapse aggregated vehicle paths to road topology by travel direction comprise program code instructions to merge redundant co-directed vehicle paths.

14. The computer program product of claim 8, wherein in response to a respective observation interval of the observation intervals extending through an intersection, the computer program product comprises program code instructions to divide the respective observation count of the respective observation interval between road topology intersecting at the intersection.

15. A method comprising:
aggregating observations and vehicle paths from sensor data from one or more data sources;
determining observation counts for each of the one or more data sources;
collapsing aggregated vehicle paths to road topology by travel direction;
assigning the observation counts to a nearest road topology;
projecting an observation count for each of the one or more data sources along a predetermined distance unit of the road topology to form observation intervals along the road topology, each observation interval comprising a respective observation count;
iterating over the road topology using the observation intervals to establish, for lengths of the road topology, observation intervals and their respective observation counts; and
determining a value of the sensor data based on lengths of the observation intervals and their respective observation counts.

16. The method of claim 15, wherein in response to the observation intervals along the road topology overlapping, superseding an observation interval having a lower observation count with an overlapping portion of an observation interval having a higher observation count.

17. The method of claim 16, wherein superseding an observation interval having a lower observation count with an overlapping portion of an observation interval having a higher observation count comprises reducing a length of the observation interval having the lower observation count by a length of the overlapping portion.

18. The method of claim 15, further comprising determining, for a respective one of the one or more data sources, a value of the sensor data provided by the respective one of the one or more data sources.

19. The method of claim 18, further comprising providing for compensation to the respective one of the one or more data sources based on the value of the sensor data.

20. The method of claim 15, wherein collapsing aggregated vehicle paths to road topology by travel direction comprises merging redundant co-directed vehicle paths.
